(19) United States
(12) Patent Application Publication
(10) Pub. No.: US 2026/0156479 A1
(43) Pub. Date: Jun. 4, 2026

(54) INFORMATION PROCESSING DEVICE, INFORMATION PROCESSING SYSTEM, INFORMATION PROCESSING METHOD, AND RECORDING MEDIUM

(71) Applicant: Panasonic Intellectual Property Management Co., Ltd., Osaka (JP)

(72) Inventors: Kyosuke ISHIHARA, Osaka (JP); Toshihiro SOTA, Osaka (JP); Ryosuke OTOMURA, Osaka (JP); Takeshi NAKAYAMA, Hyogo (JP); Hisashi NAKANISHI, Osaka (JP); Takayuki NAKAJIMA, Hyogo (JP)

(21) Appl. No.: 19/172,081

(22) Filed: Apr. 7, 2025

(30) Foreign Application Priority Data
Apr. 9, 2024 (JP) 2024-062616

(51) Int. Cl. H04W 12/64; H04W 12/71; H04W 12/77

(52) U.S. Cl. CPC H04W 12/64; H04W 12/71; H04W 12/77

(57) ABSTRACT

An inspection device includes: an obtainer that obtains a connection information item from a server that stores the connection information item in association with a user, the connection information item being an information item for connecting a device to a wireless base station to which the device is connectable, at a location at which the device is scheduled to be used by the user; and a setter that sets the connection information item obtained by the obtainer to the device.

### CROSS REFERENCE TO RELATED APPLICATION

The present application is based on and claims priority of Japanese Patent Application No. 2024-062616 filed on Apr. 9, 2024.

### FIELD

The present disclosure relates to an information processing device, an information processing system, an information processing method, and a recording medium.

### BACKGROUND

Conventionally, a code registration system is known that performs a registration process of communication setting codes on a wireless communication device prior to the wireless communication device being shipped as a product (see Patent Literature (PTL) 1, for example).

### CITATION LIST

### Patent Literature

PTL 1: Japanese Unexamined Patent Application Publication No. 2008-28788

### SUMMARY

### Technical Problem

The present disclosure provides an information processing device, an information processing system, an information processing method, and a recording medium that provide a device that can easily connect to wireless communication equipment of a user.

### Solution to Problem

An information processing device according to the present disclosure includes: an obtainer that obtains a connection information item from a server that stores the connection information item in association with a user, the connection information item being an information item for connecting a device to a wireless base station to which the device is connectable, at a location at which the device is scheduled to be used by the user; and a setter that sets the connection information item obtained by the obtainer to the device.

### Advantageous Effects

The information processing device and the like according to the present disclosure can provide a device that is capable of easily connecting to wireless communication equipment of a user.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating a usage example of an information processing system according to an embodiment.

FIG. 2 is a block diagram illustrating a configuration of the information processing system according to the embodiment.

FIG. 3 is a diagram illustrating an order table according to the embodiment.

FIG. 4 is a diagram illustrating a customer table according to the embodiment.

FIG. 5A is a flowchart illustrating a first example of processing of a server according to the embodiment.

FIG. 5B is a flowchart illustrating a second example of processing of the server according to the embodiment.

FIG. 6 is a flowchart illustrating processing of an inspection device according to the embodiment.

FIG. 7A is a sequence diagram illustrating an example of processing of the information processing system according to the embodiment.

FIG. 7B is a diagram illustrating an example of a code according to the embodiment.

FIG. 8 is a flowchart illustrating a first example of processing of a server according to Variation 1 of the embodiment.

FIG. 9 is a flowchart illustrating processing of an inspection device according to Variation 1 of the embodiment.

FIG. 10 is a sequence diagram illustrating a first example of processing of the server according to Variation 1 of the embodiment.

FIG. 11 is a flowchart illustrating processing of a delivery terminal according to Variation 1 of the embodiment.

FIG. 12 is a flowchart illustrating a second example of processing of a server according to Variation 1 of the embodiment.

FIG. 13 is a sequence diagram illustrating a second example of processing of a system according to Variation 1 of the embodiment.

FIG. 14 is a diagram illustrating a usage example of a system according to Variation 2 of the embodiment.

FIG. 15 is a diagram illustrating a first example of a connection state table according to Variation 2 of the embodiment.

FIG. 16 is a diagram illustrating a second example of the connection state table according to Variation 2 of the embodiment.

### DESCRIPTION OF EMBODIMENTS

### Underlying Knowledge Forming Basis of the Present Disclosure

Conventionally, a code registration system is known that performs a process to register communication setting codes that are necessary for communication on a plurality of wireless communication devices that are products during a process prior to when the products are shipped (see PTL 1, for example).

In the above-mentioned code registration system, a serial code is read from a communication device, such as an Internet of things (IoT) household appliance or the like, communication setting codes (a service set identifier (SSID) and a password, for example) are generated using a pseudorandom number obtained from the serial code, and the communication setting codes generated are written to the communication device. Furthermore, the communication setting codes are registered to a code management database in which the communication setting codes are associated with the serial code.

The SSID and the password generated before the product is shipped from a factory is written to a server device (television receiver, for example). Furthermore, by pairing the server device and a client device (video recording device, for example), the above-mentioned SSID and the above-mentioned password are also written to the client device. Accordingly, this makes it possible for the server device and the client device to communicate.

With the above-mentioned code registration system, it is, for example, possible to alleviate the inconvenience experienced by the user of configuring communication settings for both a television receiver and a video recording device after an audio/visual (AV) transmission device including such a television receiver and video recording device has been delivered to a home of the user.

The above-mentioned code registration system can be applied in such a case in which a plurality of devices (a server device and a client device, for example) that are communicably connected to each other are shipped from a factory at the same timing. In other words, such a code registration system is not applied in a case in which the user is to manually configure communication settings for connecting a device shipped from a factory to wireless equipment (a wireless base station, for example) that is already provided in the home of the user.

The present disclosure provides an information processing device, an information processing system, an information processing method, and a program that provide a user with a device that can easily connect to wireless communication equipment of a user.

Next, an example of an invention obtained from the information disclosed in the Specification will be given, and the advantageous effects and so on achieved by the invention will be described.

(1) An information processing device includes: an obtainer that obtains a connection information item from a server that stores the connection information item in association with a user, the connection information item being an information item for connecting a device to a wireless base station to which the device is connectable, at a location at which the device is scheduled to be used by the user; and a setter that sets the connection information item obtained by the obtainer to the device.

According to this aspect, when the device is started up at the location at which the device is scheduled to be used by the user, the device can automatically connect to the wireless base station. Here, settings for connecting the device to the wireless base station do not need to be configured by the user. This is because, at a point in time at which the device is started up at the location at which the device is scheduled to be used by the user, the device will have already been set with a connection information item for connecting the device to the wireless base station. In this manner, the information processing device can provide a device that is capable of easily connecting to wireless communication equipment of the user.

(2) The information processing device according to (1), further includes: a generator that executes a process of generating information for delivering the device to the user, the device being a device to which the connection information item has been set by the setter.

According to this aspect, the device is delivered to the user in an appropriate manner using information generated by the generation process. Thus, when the device is started up at the location at which the device has been delivered, the device can automatically connect to the wireless base station. Accordingly, the information processing device can provide a device that is capable of easily connecting to the wireless communication equipment of the user.

(3) The information processing device according to (2), in which the server further stores a delivery destination information item indicating a destination to which the device is to be delivered, the obtainer further obtains the delivery destination information item from the server, and the generator executes, as one process included in the process of generating information, a process of generating information to be indicated on a label to be attached to packing material of the device, the label including the delivery destination information item obtained by the obtainer.

According to this aspect, since a label that includes the delivery destination information item is created, delivery can be easily performed using the label created. At a point in time at which the device is to be delivered, the device that is the object to be delivered will have already been set with the connection information item that is associated with a single user, and as such, the device will need to be delivered to the user that corresponds to the device. By using the above-mentioned label, it is possible to contribute to the proper delivery of the device to the user that corresponds to the device. Accordingly, the information processing device can more appropriately provide the user with a device that is capable of easily connecting to the wireless communication equipment of the user.

(4) The information processing device according to (3), in which the server stores a plurality of sets of connection information items and delivery destination information items in association with the user, and the obtainer: selects one set among the plurality of sets; obtains a connection information item included in the one set, as the connection information item, when obtaining the connection information item; and obtains a delivery destination information item included in the one set, as the delivery destination information item, when obtaining the delivery destination information item.

According to this aspect, even in a case in which a plurality of sets of connection information items and delivery destination information items are associated with a single user, by selecting a set of connection information items and delivery destination information items from among the plurality of connection information items and delivery destination information items, it is possible to easily connect the device to the wireless communication equipment of the user in an appropriate manner. Accordingly, the information processing device can provide a device that is capable of easily connecting to the wireless communication equipment of the user.

(5) The information processing device according to (3), in which the delivery destination information item included in the label is represented as a two-dimensional code.

According to this aspect, since the delivery destination information item is represented as a two-dimensional code, it is possible to use a reading device to optically read the delivery destination information item in an easy and accurate manner. This makes it possible to perform the generation process in a more appropriate manner. Accordingly, the information processing device can more appropriately provide the user with a device that is capable of easily connecting to the wireless communication equipment of the user.

(6) The information processing device according to (2), in which the server further stores a device ID of the device, the obtainer further obtains the device ID from the server, and the generator executes, as one process included in the process of generating information, a process of generating information to be indicated on a label to be attached to packing material of the device, the label including the device ID obtained by the obtainer.

According to this aspect, since a label including the device ID is created, it is possible to prevent the delivery destination information item of the user from being discovered by a third party while the device is being delivered to the user. At a point in time at which the device is to be delivered, the device that is the object to be delivered will have already been set with a connection information item that is associated with a single user, and as such, the device will need to be delivered to the user that corresponds to the device. Furthermore, since the label does not directly include the delivery destination information item, there is an advantageous effect that the delivery destination information item is prevented from being discovered by a third party. Since the device ID on the label can be used to identify which user the device should be delivered to, the delivery destination address can be identified from the device ID itself rather than the actual delivery destination address. Furthermore, it is more difficult for a third party to use the device ID on the label to discover the delivery destination information item rather than if the actual address itself were to be used. Accordingly, the information processing device can more appropriately provide the user with a device that is capable of easily connecting to the wireless communication equipment of the user.

(7) The information processing device according to claim (6), in which the device ID included in the label is represented as a two-dimensional code.

According to this aspect, since the device ID is represented as a two-dimensional code, it is possible to use a reading device to optically read the device ID in an easy and accurate manner. This makes it possible to perform delivery in a more appropriate manner. Accordingly, the information processing device can more appropriately provide the user with a device that is capable of easily connecting to the wireless communication equipment of the user.

(8) An information processing system includes: a storage that stores a connection information item in association with a user, the connection information item being an information item for connecting a device to a wireless base station to which the device is connectable, at a location at which the device is scheduled to be used by the user; an obtainer that obtains the connection information item from the storage; and a setter that sets the connection information item obtained by the obtainer to the device.

According to this aspect, the same advantageous effects as the above-mentioned information processing device are achieved.

(9) An information processing method executed by an information processing device, in which the information processing method includes: obtaining a connection information item from a server that stores the connection information item in association with a user, the connection information item being an information item for connecting a device to a wireless base station to which the device is connectable, at a location at which the device is scheduled to be used by the user; and setting the connection information item obtained to the device.

According to this aspect, the same advantageous effects as the above-mentioned information processing device are achieved.

(10) A non-transitory computer-readable recording medium having recorded thereon a program for causing a computer to execute the information processing method according to (9).

According to this aspect, the same advantageous effects as the above-mentioned information processing device are achieved.

(11) An information processing method executed by an information processing system, the information processing system including a storage that stores a connection information item in association with a user, the connection information item being an information item for connecting a device to a wireless base station to which the device is connectable, at a location at which the device is scheduled to be used by the user, in which the information processing method includes: obtaining the connection information item from the storage; and setting the connection information item obtained to the device.

According to this aspect, the same advantageous effects as the above-mentioned information processing device are achieved.

Hereinafter, an embodiment will be described in detail by referring to the drawings as needed. However, there are instances where excessively detailed descriptions may be omitted. For example, detailed descriptions of well-known matters or repeated descriptions of elements that are essentially the same may be omitted. This is to make the following descriptions easier to understand for those skilled in the art and to avoid redundancy.

Note that the inventors and the like provide the accompanying drawings and the following descriptions not to limit the scope of the claims, but to aid those skilled in the art to adequately understand the present disclosure.

### EMBODIMENT

The present embodiment describes an information processing device and the like that can provide a device that is capable of easily connecting to wireless communication equipment of a user.

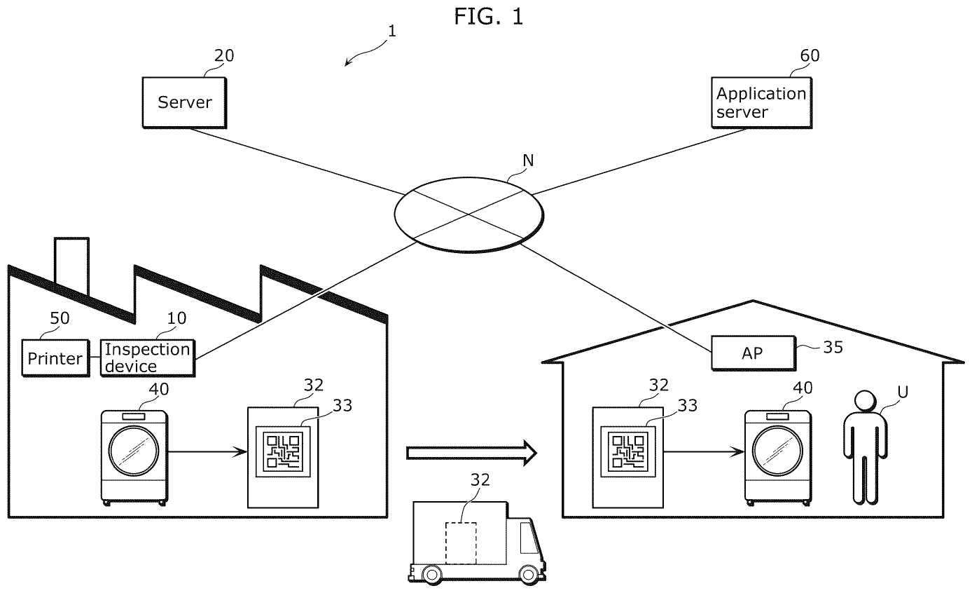

FIG. 1 is a diagram illustrating a usage example of information processing system 1 according to the present embodiment.

A usage example of information processing system 1 will be described with reference to FIG. 1, in which a flow has been assumed that starts from a stage at which household appliance 40, which has been manufactured at a factory, is ordered by a user, after which it is shipped and delivered, up to a stage at which household appliance 40 is used at a home of the user.

It should be noted that household appliance 40 and communication device 30 (described later) are examples of devices. Devices may be electronic devices (includes communication devices) that are not household appliances and the like.

As illustrated in FIG. 1, information processing system 1 includes inspection device 10 and server 20. Inspection device 10 and server 20 are communicably connected to each other via network N.

Inspection device 10 is an information processing device that performs inspection of household appliance 40, and is, for example, an industrial personal computer or a general-purpose personal computer or the like. Inspection device 10 may be connected to printer 50. Note that while printer 50 may be included in information processing system 1, printer 50 need not be included.

Inspection of household appliance 40 performed by inspection device 10 is, for example, inspection that is performed after manufacturing of household appliance 40 is complete at a point in time at which household appliance 40 has not yet been shipped, and specifically, is inspection that includes quality inspections, for example, performed on communication device 30 that is incorporated in household appliance 40. Before or after inspection or in parallel with inspection, inspection device 10 sets household appliance 40 with a connection information item for connecting to a wireless base station to which household appliance 40 is connectable, at a location at which household appliance 40 is scheduled to be used.

It should be noted that the timing at which inspection is performed by inspection device 10 on household appliance 40 may be before a stage at which communication device 30 (described later) is incorporated in household appliance 40, and may be after the stage at which communication device 30 is incorporated in household appliance 40.

Household appliance 40 is an electric device that is connectable to network N, and specifically, is a washing machine, an air conditioner, a lighting device, a refrigerator, a rice cooker, or the like. Household appliance 40 is a so-called IoT appliance. Household appliance 40 is also simply referred to as a device.

Household appliance 40 is a device ordered by user U and is scheduled to be used in a home of user U. In this case, the wireless base station to which household appliance 40 is connectable, at a location at which household appliance 40 is scheduled to be used, is base station 35 that is possessed at home by user U (indicated as an “access point (AP)” in the figures). Base station 35 can be connected to a device that has been set with a connection information item that is appropriate for connecting to base station 35. The above-mentioned connection information item set by inspection device 10 is a connection information item for household appliance 40 connecting to base station 35.

Furthermore, inspection device 10 generates information necessary to create a label that includes a delivery destination information item indicating a delivery destination of household appliance 40. The label includes code 33 that represents the delivery destination information item, and in other words, the label includes code 33 in which the delivery destination information item has been encoded. Printer 50 creates the label by printing the label based on the information necessary to create the label. The label that has been printed is attached to packing material 32 that is used to package household appliance 40. The label printed by printer 50 is visible from the exterior of household appliance 40 (or in other words, the exterior of packing material 32) when household appliance 40 is in a packaged state. Packing material 32 includes packing materials, such as a cardboard box, cushioning materials, or the like.

Server 20 is an information processing device that manages information on the user (or in other words, the customer). Server 20 is a server device, a personal computer, or the like.

Household appliance 40 is shipped and delivered in a state in which it has been packaged using packing material 32 after being manufactured at a factory, and is delivered to the home of user U who has ordered household appliance 40.

User U unpackages packing material 32 and installs household appliance 40 in the home of user U, and starts up household appliance 40. After starting up, household appliance 40 can automatically connect to base station 35. This is because household appliance 40 has already been set by inspection device 10 with a connection information item for household appliance 40 connecting to base station 35. In this manner, household appliance 40 can easily connect to base station 35.

When household appliance 40 connects to base station 35, household appliance 40 can connect to network N via base station 35, and can connect to application server 60 via network N. By connecting to application server 60, household appliance 40 can operate more appropriately and function more appropriately than in a case in which household appliance 40 includes communication device 30 and operates as a single unit. For example, this makes it possible to perform remote operation of household appliance 40.

Printer 50 includes printing unit 51 (described later). Printing unit 51 prints a quick-response (QR) code (registered trademark) that represents the delivery destination information item on the label.

Application server 60 is an information processing device that provides household appliance 40 with information (software update information, an update program, or the like) and receives information from household appliance 40. Furthermore, application server 60 may provide terminal T, which is described later, with information. Application server 60 is a server device, a personal computer, or the like.

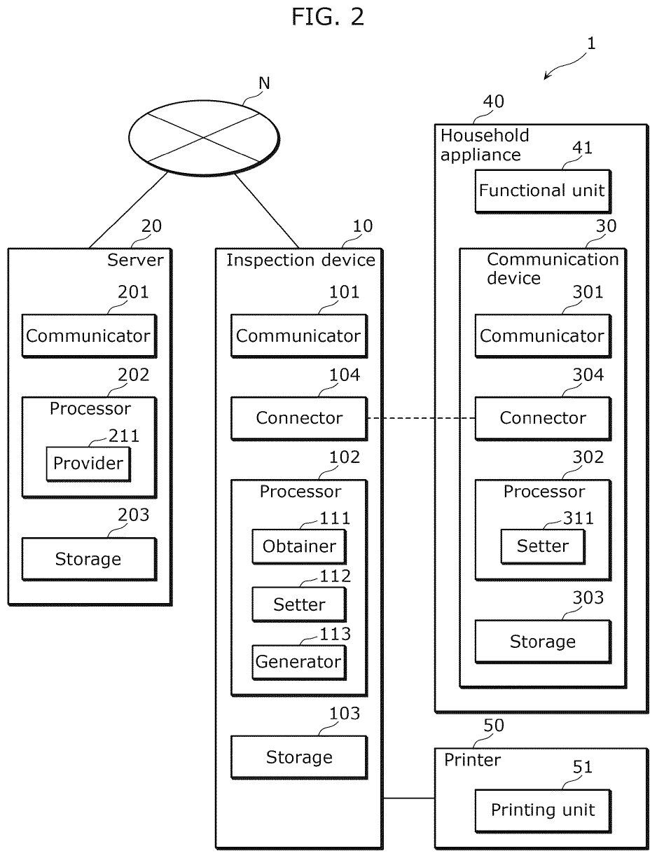

FIG. 2 is a block diagram illustrating a configuration of information processing system 1 according to the present embodiment.

Inspection device 10 includes communicator 101, processor 102, storage 103, and connector 104.

Communicator 101 is a communication interface that is communicably connected to network N. Communicator 101 may be a communication interface for a communication standard for wireless communication (such as Wi-Fi (registered trademark) or a mobile communication system (3rd Generation (3G), 4th Generation (4G), 5th Generation (5G), or the like), for example). Communicator 101 may further include a communication interface for a communication standard for wired communication (Ethernet (registered trademark) or the like, for example). Communicator 101 is used when functional units included in inspection device 10 are communicating with other devices.

By executing a program in software stored in storage 103, processor 102 allows inspection device 10 to implement a function of the software. Processor 102 is, for example, a central processing unit (CPU). Furthermore, processor 102 is connected by an internal bus to other elements included in inspection device 10, and by allowing inspection device 10 to implement the function of the software while transmitting and receiving information between the other elements, processor 102 implements obtainer 111, setter 112, and generator 113 as described below.

Obtainer 111 obtains the connection information item. The connection information item is a connection information item for connecting household appliance 40 to base station 35 that is a wireless base station to which household appliance 40 is connectable, at a location at which household appliance 40 is scheduled to be used by user U (also simply referred to as a connection information item). Obtainer 111 can obtain the above-mentioned connection information item from server 20.

Furthermore, obtainer 111 can further obtain a delivery destination information item indicating a destination to which household appliance 40 is delivered from server 20. The delivery destination information item may, for example, include address information, and may further include a name.

Setter 112 sets the connection information item obtained by obtainer 111 to household appliance 40. Specifically, by transmitting the connection information item to household appliance 40 via connector 104, setter 112 sets the connection information item transmitted to household appliance 40.

Generator 113 executes a process of generating information for delivering household appliance 40, to which the connection information item has been set by setter 112, to user U. Generator 113 can execute, as one process included in the process of generating information, a process of generating information that is necessary to create a label (information indicated on the label, for example) to be attached to packing material 32 of household appliance 40. The information necessary to create the label includes the delivery destination information item obtained by obtainer 111. More specifically, as the delivery destination information item, the label information includes code 33 in which the delivery destination information item is represented. Code 33 is, for example, a barcode, a two-dimensional code, or the like. Here, while an example will be described of a case in which code 33 is a QR code, which is a two-dimensional code, this example is not limiting.

Storage 103 is a storage device that can store information. Storage 103 can store the connection information item or the delivery destination information item obtained by obtainer 111. Furthermore, storage 103 includes random access memory (RAM) that is used as a temporary storage region when processor 102 performs information processing. Furthermore, storage 103 includes storage (a hard disk drive (HDD), a solid state drive (SSD), flash memory, or the like, for example) that stores a program executed by processor 102 and information used in processing performed by processor 102.

Connector 104 is a communication interface that is communicably connected to household appliance 40. Connector 104 may be a communication interface of a communication standard for wired communication, and may be a communication interface of a communication standard for wireless communication. Connector 104 is at least used when setter 112 is setting the connection information item to household appliance 40. Connector 104 may be used together with communicator 101, and may be provided separately.

Server 20 includes communicator 201, processor 202, and storage 203.

Communicator 201 is a communication interface communicably connected to network N. Communicator 201 may be a communication interface for a communication standard for wired communication (Ethernet (registered trademark) or the like, for example) or a communication standard for wireless communication (such as Wi-Fi (registered trademark), or a mobile communication system (3G, 4G, 5G, or the like), for example). Communicator 201 is used when functional units included in server 20 are communicating with other devices.

By executing a program in software stored in storage 203, processor 202 allows server 20 to implement a function of the software. Processor 202 is, for example, a CPU. Furthermore, processor 202 is connected by an internal bus to other elements included in server 20, and by allowing server 20 to implement the function of the software while transmitting and receiving information between the other elements, processor 202 implements provider 211 as described below.

Provider 211 provides inspection device 10 with the connection information item stored in storage 203. Provider 211 can generate the above-mentioned connection information item using order information or customer information. When provider 211 provides the connection information item, inspection device 10 sets the connection information item to household appliance 40. In other words, by providing inspection device 10 with the connection information item, provider 211 sets the connection information item provided to household appliance 40 by using inspection device 10. Together with the connection information item, provider 211 may transmit, to inspection device 10, control information to cause inspection device 10 to set household appliance 40 with the connection information item that has been provided. Inspection device 10 receives the control information transmitted, and sets the connection information item to household appliance 40 in accordance with the control information received.

It should be noted that the order information and the customer information may be information that has been registered by the user, and may be information obtained from purchasing information managed by a storefront or an E-commerce website. The order information and the customer information will be described in detail later.

Furthermore, when provider 211 provides inspection device 10 with the connection information item, inspection device 10 can execute a process for delivering household appliance 40 that has been set with the connection information item to user U (also referred to as the “generation process”). In other words, by providing inspection device 10 with the connection information item, provider 211 can cause inspection device 10 to execute the generation process for delivering household appliance 40 that has been set with the connection information item to user U. The generation process will later be described in more detail.

It should be noted that provider 211 may transmit, to inspection device 10, control information that causes inspection device 10 to execute the generation process, together with the connection information item. Inspection device 10 can receive the control information transmitted, and can execute the generation process in accordance with the control information received.

Furthermore, provider 211 provides inspection device 10 with the delivery destination information item stored in storage 203. When provider 211 provides the delivery destination information item, inspection device 10 can execute the generation process for delivering household appliance 40 to user U based on the delivery destination information item. As part of the above-mentioned process, inspection device 10 can execute a process of generating information that is necessary to create a label (information indicated on a label, for example) that is a label that includes the delivery destination information item and is to be attached to packing material 32 of household appliance 40, and an example of such a case will be described. In other words, in this case, provider 211 can cause inspection device 10 to execute a process of generating information that is necessary for creating a label that is a label that includes the delivery destination information item provided and is to be attached to packing material 32 of household appliance 40, and can cause printer 50 to print the above-mentioned label by providing inspection device 10 with the delivery destination information item.

It should be noted that provider 211 may transmit, to inspection device 10, control information that causes inspection device 10 to execute the process of generating information necessary for creating the above-mentioned label, together with the delivery destination information item. Inspection device 10 receives the control information transmitted, and executes the process of generating information that is necessary to create the label in accordance with the control information received.

As another example of the above-mentioned process, it should be noted that inspection device 10 may execute a process to directly print the delivery destination information item on household appliance 40 or packing material 32.

Storage 203 is a storage device that can store information. More specifically, in association with user U, storage 203 stores the connection information item for connecting household appliance 40 to base station 35 to which household appliance 40 is connectable, at a location at which household appliance 40 is scheduled to be used by user U. Furthermore, storage 203 stores the delivery destination information item indicating a destination to which household appliance 40 is delivered. Furthermore, storage 203 includes RAM that is used as a temporary storage region when processor 202 performs information processing. Furthermore, storage 203 includes storage (an HDD, an SSD, flash memory, or the like, for example) that stores information used in processing performed by processor 202.

Household appliance 40 includes communication device 30 and functional unit 41. Communication device 30 includes communicator 301, processor 302, storage 303, and connector 304.

Functional unit 41 implements a function unique to household appliance 40. When household appliance 40 is a washing machine, functional units 41 include a washing machine tub and a motor or the like that rotates the washing machine tub. When household appliance 40 is an air conditioner, functional units 41 include a heat pump and a heat exchanger and the like.

Communicator 301 is a communication interface that can be communicably connected to base station 35. An example will be described in which communicator 301 is a communication interface that utilizes Wi-Fi (registered trademark), which is a wireless communication standard. In this case, for example, the connection information item includes an SSID and a password and the like. By connecting to base station 35, communicator 301 connects to network N. Accordingly, communication device 30 is communicably connected to application server 60, and in other words, household appliance 40 is communicably connected to application server 60. It should be noted that the connection information item may include an IP address.

By executing a program in software, processor 302 allows communication device 30 to implement a function of the software. Processor 302 is, for example, a CPU. Furthermore, processor 302 is connected by an internal bus to other elements included in communication device 30, and by allowing communication device 30 to implement the function of the software while transmitting and receiving information between the other elements, processor 302 implements setter 311 as described below.

Setter 311 obtains the connection information item. Specifically, setter 311 obtains the connection information item provided by inspection device 10 via connector 304. Furthermore, setter 311 sets the connection information item obtained to communicator 301. It should be noted that setter 311 may obtain the connection information item from inspection device 10 by using communicator 301 instead of using connector 304.

Storage 303 is a storage device that can store information. Storage 303 can store the connection information item obtained by setter 311. Furthermore, storage 303 includes RAM that is used as a temporary storage region when processor 302 performs information processing. Furthermore, storage 303 includes storage (an HDD, an SSD, flash memory, or the like, for example) that stores information used in processing performed by processor 302.

Connector 304 is a communication interface that is communicably connected to inspection device 10. Connector 304 may be a communication interface of a communication standard for wired communication, and may be a communication interface of a communication standard for wireless communication. Connector 304 is at least used when communication device 30 (or in other words, household appliance 40) receives the connection information item that is to be set by inspection device 10. Connector 304 may be used together with communicator 301, and may be provided separately.

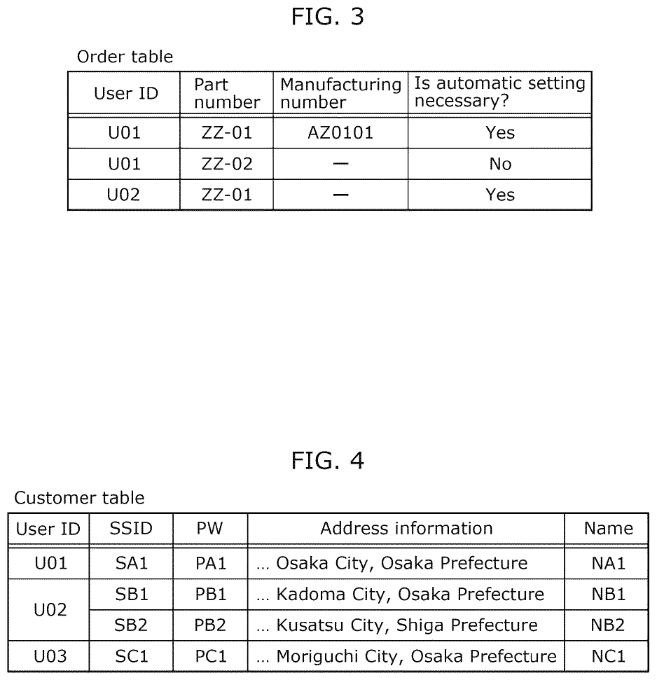

FIG. 3 is a diagram illustrating an order table according to the present embodiment. The order table illustrated in FIG. 3 is an example of order information used when provider 211 generates a connection information item.

As illustrated in FIG. 3, the order table includes one or more entries, and each entry includes information on an order for household appliance 40 that is placed by a user. The information on the orders placed by users includes a user ID, a part number, a manufacturing number, and information on the necessity of automatic setting.

A user ID indicates an identifier of the user who placed the order that corresponds to a given entry.

A part number indicates a part number of household appliance 40 that is the object being ordered that corresponds to the given entry. A part number is an identifier that indicates the model of household appliance 40. A part number is also typically referred to as a model type or a model number or the like.

A manufacturing number indicates a manufacturing number of household appliance 40 that is the object being ordered that corresponds to the given entry. A manufacturing number is an identifier that is uniquely assigned to each household appliance 40, and is an example of a device ID.

The information on the necessity of automatic setting is information that indicates whether automatic setting is necessary for household appliance 40 that is the object being ordered that corresponds to the given entry. For example, in the information on the necessity of automatic setting, when automatic setting is necessary for household appliance 40, the item is indicated as “Yes”, and when automatic setting is unnecessary for household appliance 40, the item is indicated as “No”. For a household appliance 40 that is the object being ordered for which it is indicated that automatic setting is necessary, inspection device 10 sets the household appliance 40 with the connection information item.

It should be noted that the information on the necessity of automatic setting may be set to an initial value of “Yes”, and may be configured so as to be selectable when the user places an order. For household appliances 40 for which it is impossible to perform automatic setting, such household appliances 40 may be set in advance to “No”. Household appliances 40 for which automatic setting is unnecessary and household appliances 40 for which automatic setting is impossible may each be managed by assigning separate identifiers. It should be noted that a configuration may be adopted in which household appliances 40 for which automatic setting is impossible are not included in the order table.

For example, the entry shown in the first row indicates that a user with user ID “U01” placed an order for a household appliance 40 with a part number “ZZ-01”. Furthermore, it is indicated that automatic setting is necessary for the household appliance 40 that is the object being ordered in the above-mentioned order. Additionally, the manufacturing number of the above-mentioned household appliance 40 that is to be delivered to the above-mentioned user is indicated as “AZ0101”. This manufacturing number may be information that was set by reading “AZ0101” for the above-mentioned device and transmitting this to server 20 after automatic setting was performed on the device based on the information in this entry.

For example, the entry shown in the second row indicates that the user with user ID “U01” placed an order for a household appliance 40 with a part number “ZZ-02”. Furthermore, it is indicated that automatic setting is unnecessary for the household appliance 40 that is the object being ordered in the above-mentioned order. The field for the manufacturing number of the above-mentioned household appliance 40 is left empty. The field for the manufacturing number may be set by reading the manufacturing number for the above-mentioned device and transmitting this to server 20.

For example, the entry shown in the third row indicates that a user with user ID “U02” placed an order for a household appliance 40 with a part number “ZZ-01”. Furthermore, it is indicated that automatic setting is necessary for the household appliance 40 that is the object being ordered in the above-mentioned order. The field for the manufacturing number of the above-mentioned household appliance 40 is left empty. The field for the manufacturing number may be set by reading the manufacturing number for the above-mentioned device and transmitting this to server 20.

FIG. 4 is a diagram illustrating a customer table according to the present embodiment. The customer table illustrated in FIG. 4 is an example of customer information used when provider 211 generates a connection information item or when provider 211 generates a delivery destination information item.

As illustrated in FIG. 4, the customer table includes one or more entries, and each entry includes information on a user. Information on users includes a user ID, an SSID, a password (also indicated as “PW”), address information, and a name. SSIDs and passwords can be equivalent to a connection information item and address information and names can be equivalent to a delivery destination information item.

It should be noted that there are cases where one user ID is associated with a plurality of sets of SSIDs, passwords, address information, and names (or in other words, sets of connection information items and delivery destination information items).

A user ID indicates an identifier of the user that corresponds to a given entry.

An SSID is an SSID that should be set to communication device 30 of a given household appliance 40 in order to connect household appliance 40 to a wireless base station that is possessed by the user that corresponds to the given entry.

A password is a password that should be set to communication device 30 of the given household appliance 40 in order to connect household appliance 40 to a wireless base station possessed by the user that corresponds to the given entry.

Address information is information that indicates an address of the user that corresponds to the given entry.

A name is a name of the user that corresponds to the given entry.

For example, the entry indicated in the first row includes information on a user with a user ID that is “U01”. The SSID and the password to connect household appliance 40 to a wireless base station possessed by the user are “SA1” and “PA1”, respectively. The address of the above-mentioned user is “. . . Osaka City, Osaka Prefecture”, and the name of the user is “NA1”.

For example, the entries indicated in the second row and the third row include information on a user with a user ID that is “U02”, and two sets of SSIDs and passwords (also indicated as “PW”) are associated with the user. For the first set, the SSID is “SB1”, the password is “PB1”, the address is “. . . Kadoma City, Osaka Prefecture”, and the name is “NB1”. For the second set, the SSID is “SB2”, the password is “PB2”, the address is “. . . Kusatsu City, Shiga Prefecture”, and the name is “NB2”.

It should be noted that server 20 (more specifically, provider 211) may obtain an SSID and a password from a device that has already been purchased and for which settings have been configured by a user in advance, and may manage the SSID and the password in the same manner as the above-mentioned SSIDs and passwords.

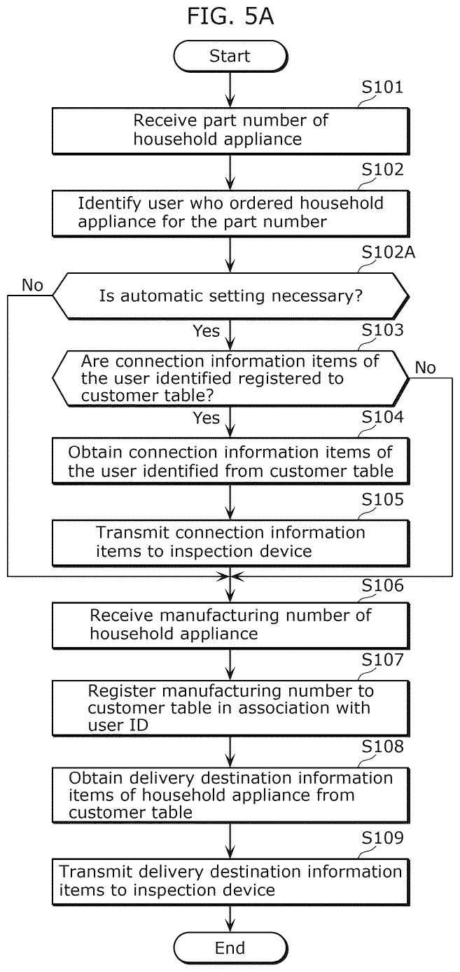

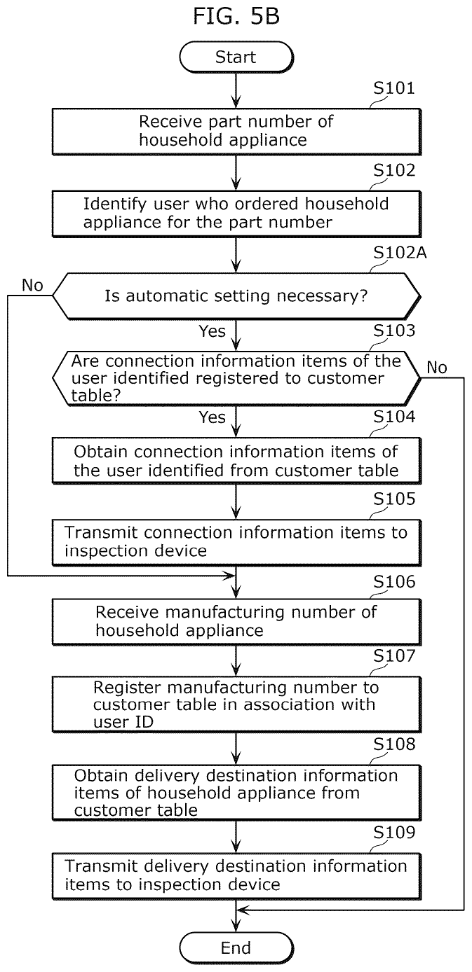

The processes of information processing system 1, as configured above, will be described with reference to FIG. 5A through FIG. 7A.

Here, a series of processes will be described, in which information processing system 1 sets a connection information item to a household appliance 40 ordered by a user, and in which a delivery destination information item is attached to packing material 32 of the household appliance 40 to which the connection information item has been set.

FIG. 5A is a flowchart illustrating a first example of processing of server 20 according to the present embodiment.

At a point in time at which step S101 has been executed, the user has completed the order (or in other words, the part number of household appliance 40 that is the object being ordered has already been determined), and the manufacturing number of the specific household appliance 40 that is to be delivered to the user has not yet been determined. In this case, in the order table (see FIG. 3), a value is set to each of the fields for user IDs and part numbers, and a value is not set to the field for manufacturing numbers (state indicated in third row in FIG. 3). Furthermore, the part number and the manufacturing number are set to storage of household appliance 40 during the manufacturing process and can be read by inspection device 10. When a manufacturing number has already been set to a given entry in the order table, it can be determined that a connection information item has already been set to the household appliance for the given entry, and this process need not be performed. Furthermore, when household appliance 40 has not been set with a manufacturing number, control information that is to be written to a separate household appliance 40 or control information to notify that a manufacturing number is to be written to a separate household appliance 40 may be sent. Furthermore, inspection device 10 may save manufacturing numbers and error details as part of a table of devices that have failed to connect.

In step S101, provider 211 receives the part number of household appliance 40 from inspection device 10 via communicator 201. The part number of household appliance 40 received by communicator 201 is the part number transmitted by inspection device 10 in step S202 (described later).

In step S102, provider 211 identifies the user that ordered the product indicated by the part number received in step S101. When the above-mentioned user is being identified, provider 211 identifies the user ID of the user for which the “part number” in the order table corresponds to the part number received in step S101. When a plurality of users exist for which the “part number” in the order table corresponds to household appliance 40 of the part number received in step S101, one user of the plurality of users may be identified as the above-mentioned user. As an identification method, a method where each of the plurality of users are ranked based on an order of priority may be used. Specifically, the order of priority may include the order in which orders have been received, the order of delivery dates, the order of shipping dates, and the like. In the above-mentioned case, the series of processes illustrated in FIG. 5A through FIG. 7A are performed for each user of the plurality of users.

In regards to the product indicated by the part number received in step S101, in step S102A, provider 211 refers to the information on the necessity of automatic setting in the entry that corresponds to the part number and user identified in the order table in steps S101 and S102, and determines whether automatic setting is necessary. When it is determined that automatic setting is necessary (“Yes” in step S102A), processing proceeds to step S103, and when it is determined otherwise (“No” in step S102A), processing proceeds to step S106.

In step S103, provider 211 determines whether the customer table has been set with the connection information item of the user identified in step S102. When it is determined that the connection information item of the above-mentioned user has been registered to the customer table (“Yes” in step S103), processing proceeds to step S104, and when it is determined otherwise (“No” in step S103), processing proceeds to step S106.

It should be noted that the customer table may be set with a plurality of sets of connection information items of the user identified in step S102. This is equivalent to a case in which a plurality of sets of connection information items and delivery destination information items are associated with a single user ID. In this case, provider 211 may select one set from the above-mentioned plurality of sets, and may use the connection information item included in the set selected. For example, when an order of priority is assigned in advance for each set, one set among the plurality of sets may be selected in accordance with the order of priority. Furthermore, the user may select one set from the plurality of sets when placing an order.

In step S104, provider 211 obtains the connection information item of the user identified in step S102 from the customer table.

In step S105, provider 211 transmits the connection information item of the user that has been obtained in step S104 to inspection device 10. When a given entry in the order table has not been set with a manufacturing number at the point in time at which step S101 has been executed, control information that notifies that inspection device 10 has not been set with a connection information item may be sent to the inspection device.

In step S106, provider 211 receives the manufacturing number of household appliance 40 via communicator 201. The manufacturing number of household appliance 40 received by communicator 201 is the manufacturing number transmitted by inspection device 10 in step S206 (described later).

In step S107, provider 211 registers the manufacturing number received in step S106 to the order table in association with the user ID of the user identified in step S102.

In step S108, provider 211 obtains the delivery destination information item of household appliance 40 from the customer table. When obtaining the above-mentioned delivery destination information item, the address information and the name of the user for which the “user ID” in the customer table corresponds to the user ID identified in step S102 are obtained as the delivery destination information item. When a plurality of connection information items are set in the customer table for the user identified in step S102, or in other words, when a plurality of sets of connection information items and delivery destination information items are associated with a single user ID, provider 211 may use the delivery destination information item included in the one set selected from the above-mentioned plurality of sets. In a case in which a plurality of sets of connection information items and delivery destination information items are associated with a single user ID, the one set selected includes the connection information item selected and the delivery destination information item included in the same set as the one set of the connection information item selected.

In step S109, provider 211 transmits the delivery destination information item obtained in step S108 to inspection device 10 via communicator 201.

In step S103, in a case where it has been determined that the connection information item of the user identified has not been registered to the customer table, the process to receive and register the manufacturing number of the device (steps S106 through S107), and the process to obtain and transmit the delivery destination information item (steps S108 through S109) need not be executed. An example of a flowchart that illustrates such a case is shown in FIG. 5B. In this case, server 20 does not transmit the delivery destination information item of the household appliance 40 ordered by the user for which a connection information item has not been registered to the customer table.

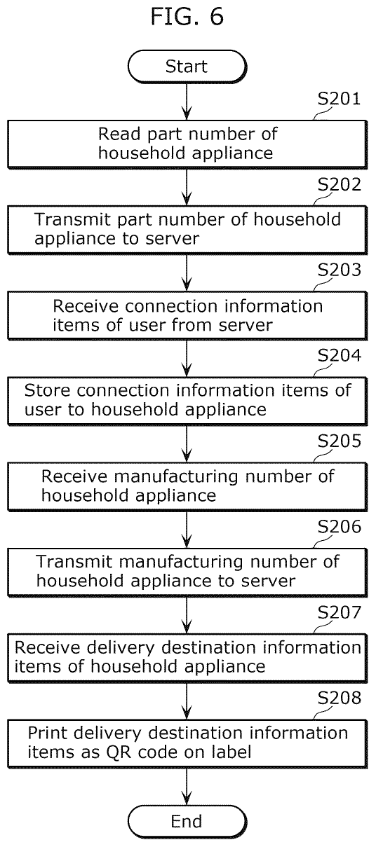

FIG. 6 is a flowchart illustrating processing of inspection device 10 according to the present embodiment.

In step S201, obtainer 111 uses connector 104 to read the part number of the household appliance 40 that is the object being inspected by inspection device 10. It should be noted that the part number of a given household appliance 40 may be indicated on a label that is in one-to-one correspondence with the given household appliance 40 and is attached to the given household appliance 40. The label may be attached to the housing of the given household appliance 40, or may be disposed near the given household appliance 40. In this case, the part number of household appliance 40 may be represented as a barcode or characters or the like. Inspection device 10 can allow a worker to obtain a part number by operating a scanner connected to inspection device 10, and by using the scanner to read the part number indicated on a label. It should be noted that inspection device 10 may use an imaging device to determine the part number based on the appearance of household appliance 40.

When a plurality of household appliances 40 are present, the label may be a label that is disposed in a location that is close to the household appliance 40 to which the label is associated, and closer than the household appliances 40 among the plurality of household appliances 40 that are different from the household appliance 40 to which the label is associated. More specifically, the label may be a label that is attached to the household appliance 40 to which the label is associated.

In step S202, obtainer 111 transmits the part number of household appliance 40 that is read in step S201 to server 20 via communicator 101.

In step S203, setter 112 receives the connection information item of the user from server 20. The connection information item received is the connection information item transmitted by server 20 in step S105 (see FIG. 5A or FIG. 5B).

In step S204, setter 112 stores the connection information item received in step S203 to household appliance 40. Specifically, setter 112 transmits the connection information item received in step S203 to household appliance 40 via a connection between connector 104 and connector 304, and transmits control information, to household appliance 40, to cause household appliance 40 to store the connection information item to communication device 30 (or more specifically, storage 303). Household appliance 40 that receives the above-mentioned connection information item and the control information stores the above-mentioned connection information item to communication device 30 (or more specifically, storage 303).

In step S205, obtainer 111 receives the manufacturing number of household appliance 40 via connector 104. Specifically, processor 302 of household appliance 40 reads the manufacturing number from storage 303 and transmits the manufacturing number via connector 304, and obtainer 111 receives the manufacturing number transmitted.

Instead of receiving the manufacturing number of household appliance 40 in the manner described above, obtainer 111 may read the manufacturing number of the household appliance 40 that is the object being inspected by inspection device 10. The manufacturing number of a given household appliance 40 may, for example, be indicated on a label that is in one-to-one correspondence with the given household appliance 40 and is attached to the given household appliance 40. The label may be attached to the housing of the given household appliance 40, or may be disposed near the given household appliance 40.

In step S206, obtainer 111 transmits the manufacturing number of household appliance 40 that is received in step S205 to server 20 via communicator 101. It should be noted that in step S201, the manufacturing number may be read together with the part number, and the manufacturing number and the part number may be stored by inspection device 10. In this case, the manufacturing number may be registered to server 20 when setting of the connection information item to household appliance 40 is complete.

In step S207, obtainer 111 receives the delivery destination information item of household appliance 40 via communicator 101. The delivery destination information item received is the delivery destination information item transmitted by server 20 in step S109 (see FIG. 5A or FIG. 5B).

In step S208, generator 113 generates a QR code that represents the delivery destination information item received by obtainer 111 in step S207. Printing unit 51 prints the QR code generated by generator 113 as a label. The label on which the QR code is printed may be attached to household appliance 40 by inspection device 10, and may be attached to household appliance 40 by a worker.

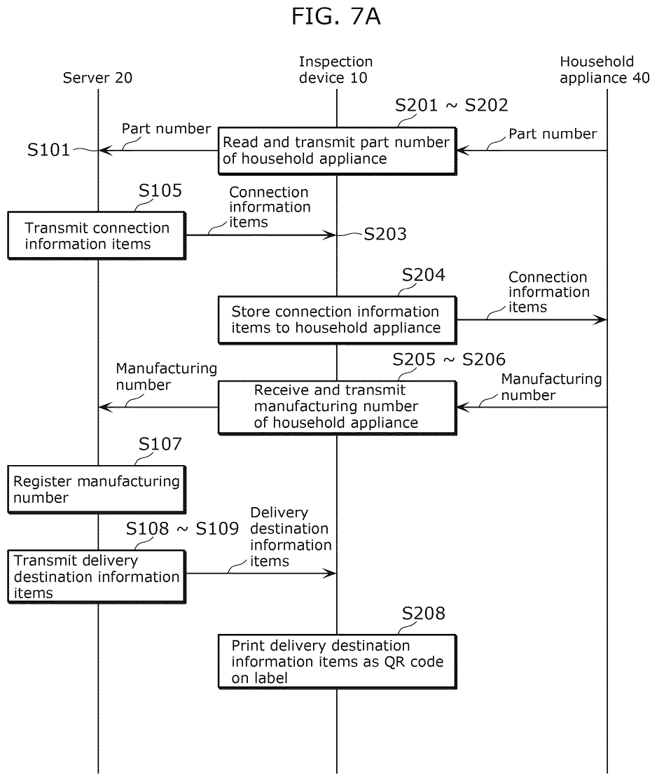

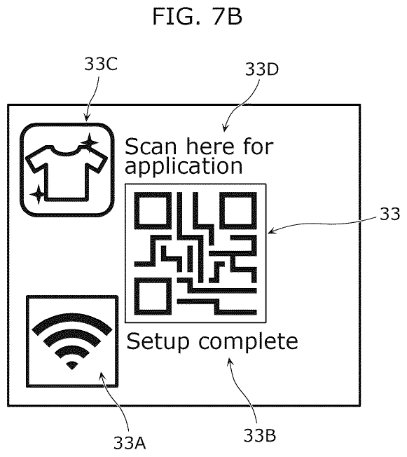

FIG. 7A is a sequence diagram illustrating an example of processing of information processing system 1 according to the present embodiment.

FIG. 7A illustrates a flow of processes executed by information processing system 1 in a case where a connection information item of a user is registered to a customer table. Since the processing steps of inspection device 10 and server 20 illustrated in FIG. 7A are the same as the processing steps having the same names that are illustrated in FIG. 5A, FIG. 5B, and FIG. 6, description of these processes is omitted. In FIG. 7A, a portion of the processing steps indicated in FIG. 5A, FIG. 5B, and FIG. 6 are omitted.

Furthermore, FIG. 7A illustrates the flow of processes executed by information processing system 1 when provider 211 determines that the connection information item of the user identified in step S103 in FIG. 5A or FIG. 5B is registered to the customer table (“Yes” in step S103 (see FIG. 5A or FIG. 5B)).

The connection information item for connecting to the base station 35 possessed by the user is set to household appliance 40 by the processes illustrated in FIG. 7A. Furthermore, a household appliance 40 to which the connection information item has been set in this manner is delivered to the user using the delivery destination information item printed on the label.

After household appliance 40 is delivered to the user, and household appliance 40 is started up at the location at which household appliance 40 is scheduled to be used by the user, the processor of household appliance 40 reads the connection information item stored in storage 303 and sets communicator 301 with the connection information item. Communicator 301 performs an authentication process between communicator 301 and base station 35 using the connection information item, and when authentication is successful, household appliance 40 can connect to base station 35. Here, the user does not need to configure settings for connecting household appliance 40 to base station 35. In this manner, information processing system 1 can provide a device that is capable of easily connecting to wireless communication equipment of a user.

It should be noted that the QR code generated by generator 113 may further include a name of household appliance 40, setting information of household appliance 40 (information on applications that control household appliance 40), a part number of household appliance 40, information indicating the necessity of automatic setting, and a uniform resource locator (URL) of a web page on which information on household appliance 40 is posted.

It should be noted that information on wireless communication settings and information on applications that control household appliance 40 may be added in the vicinity of the QR code. Such information will be described with reference to FIG. 7B.

FIG. 7B is a diagram illustrating an example of a code according to the present embodiment.

The QR code illustrated in FIG. 7B is encoded with a URL for installing an application to control household appliance 40.

In FIG. 7B, information indicating that the configuration of wireless communication settings (or in other words, setup) is complete is provided in the vicinity of code 33, which is a QR code. Specifically, as part of the above-mentioned information, FIG. 33A that indicates wireless communication and character string 33B that includes the words “Setup complete” are provided. By viewing the information indicating that the configuration of wireless communication settings is complete, the user can identify that the configuration of settings for connecting household appliance 40 to base station 35 at the user's home have already been completed.

Furthermore, in FIG. 7B, information on applications that control household appliance 40 are provided in the vicinity of code 33, which is a QR code. Specifically, as part of the above-mentioned information, image 33C indicating that household appliance 40 is compatible with an application and character string 33D that includes the words “Scan here for application” are provided. The user can identify that an application for controlling household appliance 40 exists and can read the QR code using a terminal, thereby making it possible to easily obtain the application for controlling household appliance 40 by accessing the URL to install the application.

### Variation 1 of Embodiment

In the present variation, an aspect that is different from the above-mentioned embodiment is described of an information processing device and the like that can provide a device that is capable of easily connecting to wireless communication equipment of a user. Specifically, an example will be described in which a QR code generated by inspection device 10 includes a manufacturing number instead of a delivery destination information item. In this case, an information terminal (also referred to as a delivery terminal) possessed by a delivery worker is used.

In the present variation, the points of difference from the above-mentioned embodiment will be described as follows.

In the present variation, information processing system 1 executes a process to create a label for household appliance 40 (or in other words, packing material 32).

Specifically, obtainer 111 of inspection device 10 obtains a manufacturing number of household appliance 40. Here, obtainer 111 obtains the manufacturing number of household appliance 40 from server 20. It should be noted that inspection device 10 may obtain the manufacturing number that is read and stored by inspection device 10 by reading the manufacturing number.

Furthermore, generator 113 of inspection device 10 executes, as one process included in the generation process, a process of generating information (label information) for creating a label, which is a label that includes the manufacturing number obtained by obtainer 111, to be attached to packing material 32 of household appliance 40. The manufacturing number included in the label is represented as a barcode or a two-dimensional code, for example.

Provider 211 of server 20 provides inspection device 10 with the manufacturing number of household appliance 40. When provider 211 provides inspection device 10 with the manufacturing number, inspection device 10 executes a process of generating information necessary for creating a label, which is a label that includes the manufacturing number, to be attached to packing material 32 of household appliance 40. In other words, by providing inspection device 10 with the manufacturing number, provider 211 can cause inspection device 10 to execute a process to create label information for a label, which is a label that includes the manufacturing number, to be attached to packing material 32 of household appliance 40. It should be noted that provider 211 may transmit, to inspection device 10, control information that causes inspection device 10 to execute the process of generating information necessary for creating the label, together with the manufacturing number. Inspection device 10 can receive the control information transmitted, and execute the process of generating information that is necessary to create the label in accordance with the control information received.

Hereinafter, a process for creating the above-mentioned label and a process for delivering household appliance 40 will be described in detail.

### Process for Creating Label

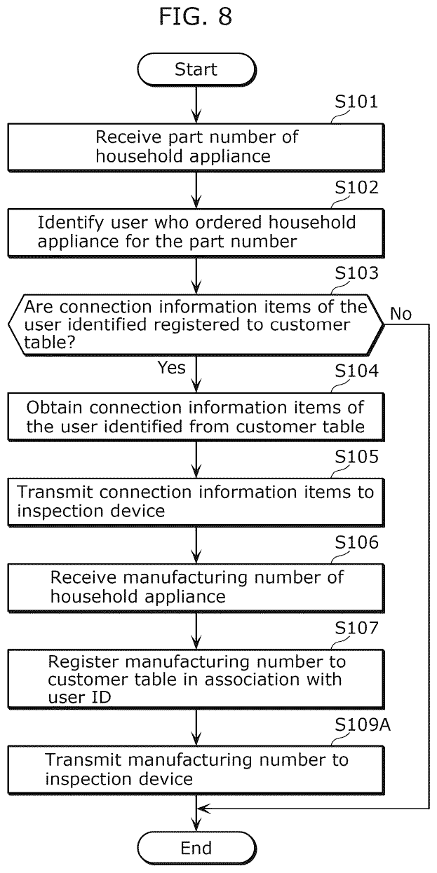

The process of information processing system 1 for creating a label will be described with reference to FIG. 8 through FIG. 10.

FIG. 8 is a flowchart illustrating processing of a server according to Variation 1 of the embodiment.

Steps S101 through S107 illustrated in FIG. 8 are the same as the processes (steps S101 through S107) of server 20 in the above-mentioned embodiment.

After step S107 is executed, provider 211 executes step S109A.

In step S109A, provider 211 transmits the manufacturing number received in step S106 to inspection device 10 via communicator 201.

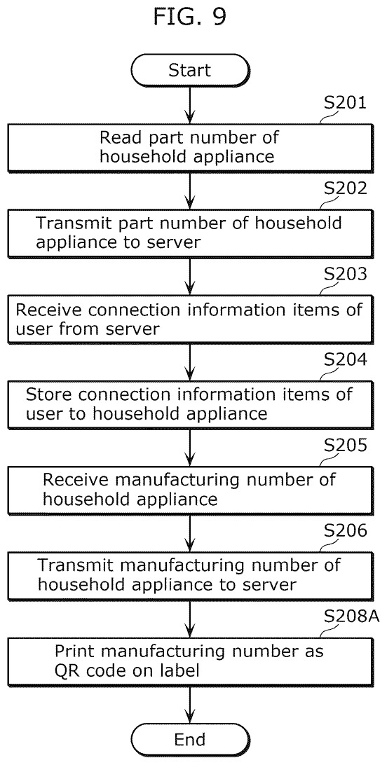

FIG. 9 is a flowchart illustrating processing of inspection device 10 according to Variation 1 of the embodiment.

Steps S201 through S206 illustrated in FIG. 9 are the same as the processes (steps S201 through S206) of inspection device 10 in the above-mentioned embodiment.

After step S206 is executed, generator 113 executes step S208A.

In step S208A, generator 113 generates label information that includes the manufacturing number as a QR code, and uses printer 50 to print the label. The label on which the QR code is printed may be attached to household appliance 40 by inspection device 10, and may be attached to household appliance 40 by a worker.

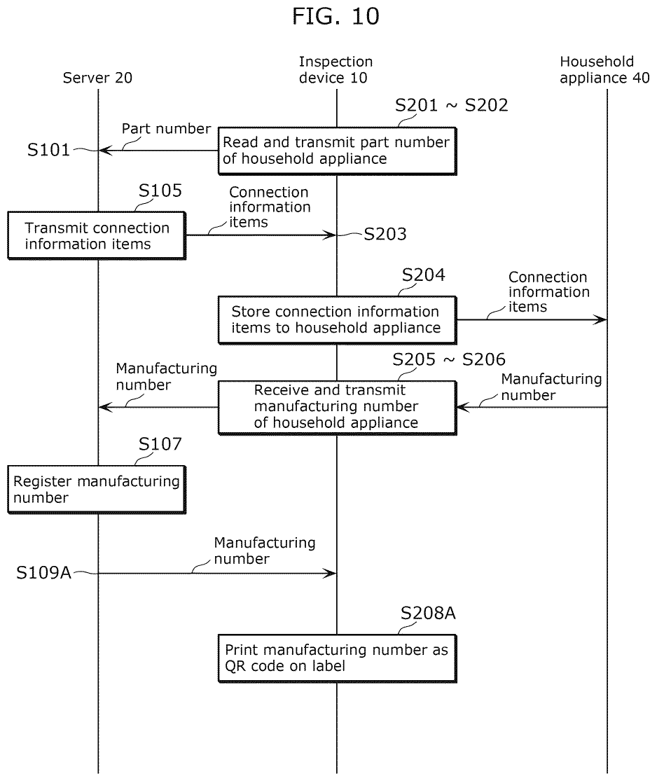

FIG. 10 is a sequence diagram illustrating a first example of processing of a system according to Variation 1 of the embodiment.

FIG. 10 illustrates a flow of processes executed by information processing system 1 in a case where a connection information item of a user is registered to a customer table. Since the processing steps of inspection device 10 and server 20 illustrated in FIG. 10 are the same as the processing steps having the same names that are illustrated in FIG. 8 and FIG. 9, description of these processes is omitted. In FIG. 10, a portion of the processing steps indicated in FIG. 8 and FIG. 9 are omitted.

Furthermore, FIG. 10 illustrates the flow of processes executed by information processing system 1 when provider 211 determines that the connection information item of the user identified in step S103 in FIG. 8 is registered to the customer table (“Yes” in step S103 (see FIG. 8)).

The connection information item for connecting to the base station 35 possessed by the user is set to household appliance 40 by the processes illustrated in FIG. 10. Furthermore, label information to be attached to household appliance 40 that has been set with the connection information item in this manner is generated by inspection device 10, and is printed by printer 50.

### Process for Delivering Household Appliance 40

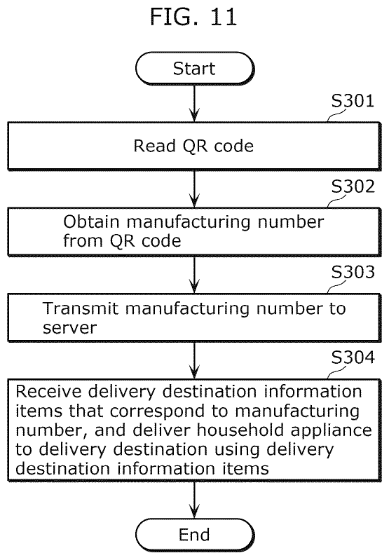

The processes of information processing system 1 for delivering household appliance 40 will be described with reference to FIG. 11 through FIG. 13.

In information processing system 1, processes for delivering household appliance 40 are executed by a terminal used in delivery work (also referred to as a delivery terminal) and server 20. The delivery terminal is, for example, an information terminal that is possessed by a delivery worker who is in charge of delivering household appliance 40.

FIG. 11 is a flowchart illustrating processing of a delivery terminal according to Variation 1 of the embodiment.

In step S301, the delivery terminal reads a QR code. The QR code read by the delivery terminal is the QR code that is printed in step S208A.

In step S302, the delivery terminal obtains a manufacturing number of household appliance 40 from the QR code read in step S301.

In step S303, the delivery terminal transmits the manufacturing number obtained in step S302 to server 20.

In step S304, the delivery terminal receives a delivery destination information item that corresponds to the manufacturing number obtained in step S302 from server 20.

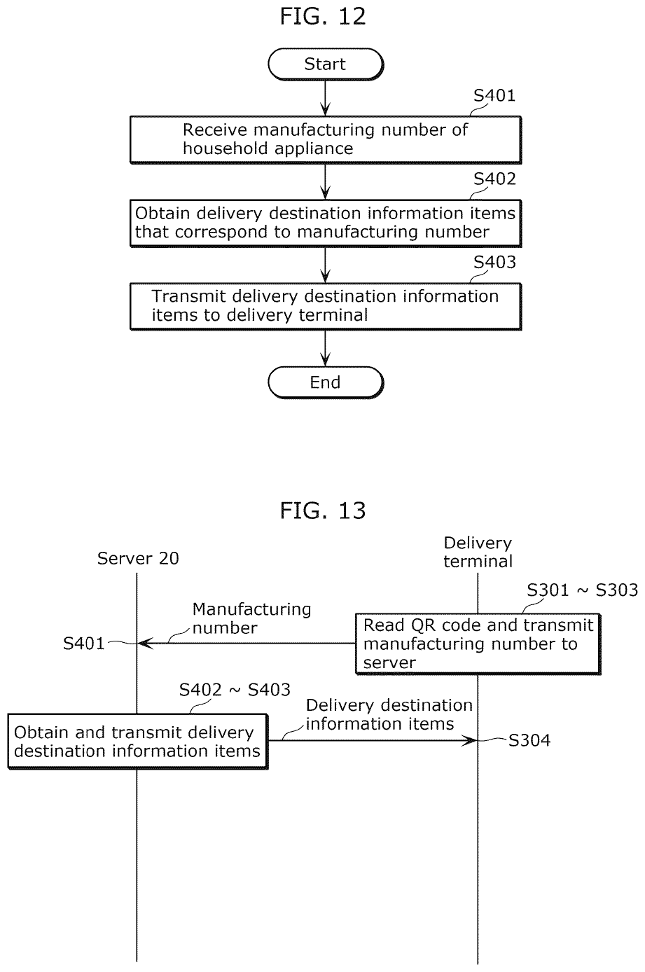

FIG. 12 is a flowchart illustrating a second example of processing of server 20 according to Variation 1 of the embodiment.

In step S401, provider 211 receives the manufacturing number of household appliance 40 via communicator 201. The manufacturing number received by provider 211 is the manufacturing number transmitted by the delivery terminal in step S303.

In step S402, provider 211 obtains the delivery destination information item that corresponds to the manufacturing number received in step S401. Specifically, provider 211 identifies, in the order table (see FIG. 3), a user ID that includes a manufacturing number that matches the manufacturing number received in step S401, and then obtains, from the customer table (see FIG. 4), the delivery destination information item (i.e., address information and name) that corresponds to a user ID that matches the above-mentioned user ID identified.

In step S403, provider 211 transmits the delivery destination information item obtained in step S402 to the delivery terminal.

FIG. 13 is a sequence diagram illustrating a second example of processing of the system according to Variation 1 of the embodiment.

FIG. 13 illustrates the processes of information processing system 1 for delivering household appliance 40. Since the processing steps of server 20 and the delivery terminal illustrated in FIG. 13 are the same as the processing steps having the same names that are illustrated in FIG. 11 and FIG. 12, description of these processes is omitted. In FIG. 13, a portion of the processing steps indicated in FIG. 11 and FIG. 12 are omitted. The processes illustrated in FIG. 13 are executed after the processes illustrated in FIG. 10.

With the processes illustrated in FIG. 13, the delivery terminal reads the QR code attached to household appliance 40 to obtain the manufacturing number, and receives the delivery destination information item from server 20. The delivery worker can deliver household appliance 40 to the delivery destination using the delivery destination information item presented by the delivery terminal. Here, the delivery terminal may further include a printing function, and may print a label that includes the delivery destination information item. The delivery worker can attach the label printed to household appliance 40 or packing material 32, and can thereby deliver household appliance 40.

After household appliance 40 is delivered to the user, and household appliance 40 is started up at the location at which household appliance 40 is scheduled to be used by the user, household appliance 40 can automatically connect to base station 35. Here, settings for connecting household appliance 40 to base station 35 do not need to be configured. In this manner, information processing system 1 can provide a device that is capable of easily connecting to wireless communication equipment of a user.

### Variation 2 of Embodiment

In the present variation, an aspect that is different from the above-mentioned embodiment is described, of an information processing device and the like that can provide a device that is capable of easily connecting to wireless communication equipment of a user. Specifically, an example will be described in which household appliance 40 connects to base station 35, and user U is notified that communication with application server 60 is possible after household appliance 40 has been delivered.

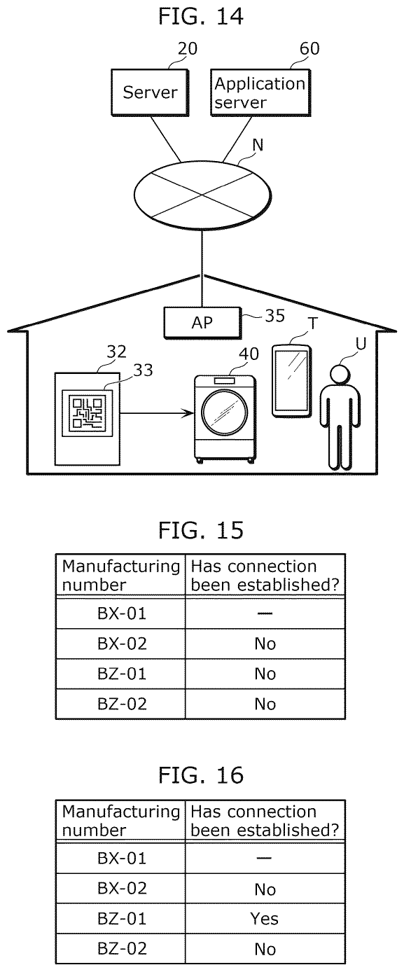

FIG. 14 is a diagram illustrating a usage example of information processing system 1 according to the present variation.

In the present variation, user U possesses terminal T. Terminal T is registered to application server 60 as a terminal possessed by user U. Application server 60 holds connection state information that indicates whether household appliance 40 is connected to application server 60 via base station 35.

FIG. 15 is a diagram illustrating a first example of a connection state table according to the present variation. FIG. 16 is a diagram illustrating a second example of a connection state table according to the present variation. The connection state tables illustrated in FIG. 15 and FIG. 16 are examples of connection state information that is held by application server 60.

As illustrated in FIG. 15, the connection state table includes one or more entries, and each entry includes information on household appliances 40. The information on household appliances 40 includes manufacturing numbers and information items on whether a connection has been established.

The manufacturing number indicates a manufacturing number of household appliance 40 that corresponds to a given entry. A manufacturing number is an identifier that is uniquely assigned to each household appliance 40.

The information item on whether a connection has been established indicates whether the household appliance 40 corresponding to the given entry has communicated with application server 60 at least once. For example, for the information item on whether a connection has been established, when household appliance 40 has communicated with application server 60 at least once, “Yes” is indicated in the information item, and when household appliance 40 has not been communicably connected to application server 60, “No” is indicated in the information item. For household appliances 40 that do not include a function to communicate with application server 60, “-” is indicated in the information item on whether a connection has been established.

For example, the entry shown in the first row indicates that the household appliance 40 for which the manufacturing number is “BX-01” is not capable of communicating with application server 60.

Furthermore, the entry shown in the second row indicates that the household appliance 40 for which the manufacturing number is “BX-02” has not been connected to application server 60.

Furthermore, the entry shown in the third row indicates that the household appliance 40 for which the manufacturing number is “BZ-01” has not been connected to application server 60.

As described above, the connection state table shown in FIG. 15 indicates that the household appliance 40 for which the manufacturing number is “BZ-01” has not been connected to application server 60. Here, when the household appliance 40 for which the manufacturing number is “BZ-01” has been connected to application server 60, the connection state table is updated to indicate that the household appliance 40 for which the manufacturing number is “BZ-01” has been connected to application server 60. A connection state table that has been updated in this manner is illustrated in FIG. 16.

When a manufacturing number is written to the order table, an entry that includes the manufacturing number written is generated in the connection state table. Furthermore, when user U accesses server 20 and manually registers a manufacturing number (so-called user registration), an entry is generated in the connection state table. When an entry is being generated, the manufacturing number can be used to determine whether the device is capable of communication, and during generation of the entry, the information item is set to “-” if the device is not capable of communication, and the information item is set to “No” if the device is capable of communication.

When household appliance 40 connects to base station 35, household appliance 40 becomes capable of communicating with server 20 via base station 35 and network N, and the manufacturing number of household appliance 40 is transmitted to server 20 using such communication. Server 20 can use the manufacturing number of household appliance 40 transmitted to update the connection state table.

In FIG. 16, the entry shown in the third row indicates that the household appliance 40 for which the manufacturing number is “BZ-01” has been connected to application server 60.

In this manner, when household appliance 40 and application server 60 switch from a state in which they have not been connected to a state in which they have been connected, application server 60 can update the connection state table.

Application server 60 may transmit notification information to terminal T when the connection state table is updated. When the above-mentioned notification information is received, terminal T may present user U with the details of the above-mentioned notification information by displaying the details on a display screen. The above-mentioned notification information may be information indicating that the connection state table has been updated, and may be information indicating that the household appliance 40 for which the manufacturing number is “BZ-01” has been connected to application server 60.

Application server 60 may transmit request information to terminal T to request that a household appliance 40, for which the information item on whether a connection has been established is “No”, be connected to base station 35 or application server 60. When the request information is received, terminal T may present user U with the details of the request information by displaying the details on a display screen. It is assumed that the user who has viewed the details of the request information will connect the household appliance 40, for which the information item on whether a connection has been established is “No”, to base station 35.

As described above, the embodiment has been described to exemplify the techniques of the present disclosure. Toward this end, the accompanying drawings and detailed descriptions have been provided.

Consequently, the elements described in the accompanying drawings and detailed descriptions include not only those elements essential to solving the problem, but they may also include elements which, while not being essential to solving the problem, have been included in order to exemplify the aforementioned implementation. For this reason, such non-essential elements should not readily be deemed to be essential based on the mere fact that they are described in the accompanying drawings and detailed descriptions.

Moreover, the above-mentioned embodiment is used to exemplify techniques described in the present disclosure. Thus, various modifications, substitutions, additions, omissions, or the like can be made within the scope of the claims and the equivalents thereof.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to a system that provides a device that can connect to wireless communication equipment of a user.

1. An information processing device comprising:
an obtainer that obtains a connection information item from a server that stores the connection information item in association with a user, the connection information item being an information item for connecting a device to a wireless base station to which the device is connectable, at a location at which the device is scheduled to be used by the user; and
a setter that sets the connection information item obtained by the obtainer to the device.

2. The information processing device according to claim 1, further comprising:
a generator that executes a process of generating information for delivering the device to the user, the device being a device to which the connection information item has been set by the setter.

3. The information processing device according to claim 2, wherein
the server further stores a delivery destination information item indicating a destination to which the device is to be delivered,
the obtainer further obtains the delivery destination information item from the server, and
the generator executes, as one process included in the process of generating information, a process of generating information to be indicated on a label to be attached to packing material of the device, the label including the delivery destination information item obtained by the obtainer.

4. The information processing device according to claim 3, wherein
the server stores a plurality of sets of connection information items and delivery destination information items in association with the user, and
the obtainer:
selects one set among the plurality of sets;
obtains a connection information item included in the one set, as the connection information item, when obtaining the connection information item; and
obtains a delivery destination information item included in the one set, as the delivery destination information item, when obtaining the delivery destination information item.

5. The information processing device according to claim 3, wherein
the delivery destination information item included in the label is represented as a two-dimensional code.

6. The information processing device according to claim 2, wherein
the server further stores a device ID of the device,
the obtainer further obtains the device ID from the server, and
the generator executes, as one process included in the process of generating information, a process of generating information to be indicated on a label to be attached to packing material of the device, the label including the device ID obtained by the obtainer.

7. The information processing device according to claim 6, wherein
the device ID included in the label is represented as a two-dimensional code.

8. An information processing system comprising:
a storage that stores a connection information item in association with a user, the connection information item being an information item for connecting a device to a wireless base station to which the device is connectable, at a location at which the device is scheduled to be used by the user;
an obtainer that obtains the connection information item from the storage; and
a setter that sets the connection information item obtained by the obtainer to the device.

9. An information processing method executed by an information processing device, the information processing method comprising:
obtaining a connection information item from a server that stores the connection information item in association with a user, the connection information item being an information item for connecting a device to a wireless base station to which the device is connectable, at a location at which the device is scheduled to be used by the user; and
setting the connection information item obtained to the device.

10. A non-transitory computer-readable recording medium having recorded thereon a program for causing a computer to execute the information processing method according to claim 9.

11. An information processing method executed by an information processing system, the information processing system including a storage that stores a connection information item in association with a user, the connection information item being an information item for connecting a device to a wireless base station to which the device is connectable, at a location at which the device is scheduled to be used by the user, the information processing method comprising:
obtaining the connection information item from the storage; and
setting the connection information item obtained to the device.
